(19) United States
(12) Patent Application Publication
(10) Pub. No.: US 2008/0069696 A1
(43) Pub. Date: Mar. 20, 2008

(54) Tension Windmill

(76) Inventor: Newton Evans Ball, Hemet, CA (US)

Correspondence Address: LITTLE B. COMPANY;ATTN: SARAH BARKER-BALL, 24113 SARGEANT ROAD, RAMONA, CA, 92065, US

(21) Appl. No.: 11/838,201

(22) Filed: Aug. 13, 2007

Related U.S. Application Data
(60) Provisional application No. 60/845,066, filed on Sep. 15, 2006.

(51) Int. Cl. F03D 1/06

(52) U.S. Cl. 416/132 B

(57) ABSTRACT

A windmill design in which all rigid blades are replaced by sail-type Blades that are only supported by tension. Each Blade is connected to a central Hub and outer Rim by means of two Spokes, and is twisted in shape to maintain a materially constant free wheeling angular velocity at any radial location along the Blade while preserving a near-constant width. The cross section of the Rim is wing-shaped to produce laminar flow of air over the Blades.

### CROSS-REFERENCE TO RELATED APPLICATIONS

This application claims the benefit of U.S. Provisional Application No. 60/845,066, filed Sep. 15, 2006, entitled TENSION WINDMILL, which is incorporated herein by reference in its entirety.

### TECHNICAL FIELD

The present invention relates to a windmill which is used for increased efficiency in wind power generation.

### BACKGROUND OF THE INVENTION

Windmills and wind turbines currently in widespread use are relatively inefficient devices for converting available wind energy into useable mechanical energy. The shank and propeller must be designed to withstand the various forces caused by the structure's shape and motion, and in such a manner as to account for confluence of moving air streams. These stress forces on the shank primarily include torsion, bending and tension, and are caused by aerodynamics (lift and drag), gravitational pull and centripetal acceleration acting on the rotating blades. The power output of a wind turbine is proportional to the effective surface area of the blades in contact with the wind (henceforth called “sail area”), but the airfoil shape of axial flow wind machines propeller blades presents a small such area. Near the hub, these blades must be very thick, in order to withstand bending moments caused during rotation. Close to the turbine's center, therefore, the blades are effectively beams, with a poor lift to drag ratio. Elsewhere, the blade airfoil must be fairly narrow, so that twisting and bending forces do not overload the shank of the wind turbine.

Increasing the sail area of the blades yields a higher ratio of power conversion. Blades with a larger diameter are therefore capable of extracting more power from the wind, but as wind turbines are scaled up in size, the mechanism needs to become drastically stronger. The hub must first support the dramatic increase in weight of the blades themselves. Even relatively small windmills suited for residential purposes, with rated power outputs of 10 kW or less, nevertheless must support blades which typically weigh between 4 kg (8.8 lbs) and 10 kg (22 lbs) each. Secondly, larger dimensions create greater discrepancies between wind speeds at opposite extremes of the blade rotation and this substantially increases the varying gravitational loads or bending forces between opposing blade edges. Hence, rigid blades of greater length cause further stress to the mechanism and efficiency losses in torque conversion. Other inventions which use sail-type blades in place of rigid blades, such as U.S. Pat. No. 6,402,472, still support such blades by relatively thick arms or spars, thus maintaining some of the problematic bending moments characteristic of rigid blade-type systems.

Replacing the rigid blades or supporting arms with tension-loaded sail-type blades has the further environmental advantage of reducing danger to birds. Avian mortality has become increasingly problematic with the global expansion of wind power systems. Birds are often unable to see the quickly rotating blades and fly into their path while seeking ground-level prey. The tension windmill could alleviate this problem because even in strong winds, all components rotate at a slower rate than their rigid-blade counterparts. The external Rim is the only inflexible member to rotate, and its large circular shape retains visibility at any speed.

Furthermore, most establishments that use wind machines to convert energy are controlled such that all the machines turn synchronously to the AC line, regardless of wind conditions. This method reduces efficiency and increases the potential for the machines to sustain damage during times of especially strong winds, when the output power is greater than the rated power of the turbines. By controlling a system of windmills such that their rotation is dependent upon present wind conditions, the machines can consistently extract more energy during normal conditions and avoid damage when wind speeds are dangerously high.

### BRIEF SUMMARY OF THE INVENTION

This novel design for a Tension Windmill will replace rigid turbine blades with fabric Blades resembling twisted “sails”. This will dramatically increase the contact area presented to the wind, or sail area, and consequently the potential power extraction from it. Unlike both rigid blade-type and other sail-type windmill designs, the Blades of the present invention will be entirely loaded in tension, causing considerably less stress to the shaft while changing the nature of the force on the rotating members to eliminate bending forces.

The Tension Windmill's mechanical structure consists primarily of a central Hub, a circular outer Rim, and a plurality of Blades between the Hub and Rim. Each Blade is constructed of a fabric material that can tolerate compound bends. This flat fabric is stretched between two Spokes, resembling the spokes of a bicycle wheel, which are attached at opposite ends to the Hub and Rim by clamps, distinguished by the respective labels H-Clamps and R-Clamps. The distance between the two Spokes for each Blade is nearly constant, but they are not aligned in parallel. The fabric between the Spokes is twisted into a shape that effectively accommodates a constant wind speed at any radial distance from the Hub. This twist maintains a near-constant width in the fabric, but causes a smoothly varying angle of attack (angle between the plane of the fabric and the wind direction). The angle of attack of any portion of the Blade is proportional to its distance from the Hub. This design maintains a smooth laminar flow of air when the Blade's rotation is slowed by the load (the electrical power generator). Therefore, there is a nearly constant angular velocity at any radius and the fabric Blade does not need to support bending moments. The shape also greatly increases the mechanism's sail area as compared to a rigid turbine of the same diameter. The twisted shape and consequent radial variance of the angle of attack are supported on both sides by the Blade's paired Spokes and thus maintains stability at any rotational speed. There is no need for springs or other devices designed to change the Blade's angle during its rotation about the Hub.

When rotating at speed, the Blades and Spokes are loaded in tension only. Tension members weigh dramatically less than equal-sized shapes that must support gravitational bending moments. Consequently, this design can be scaled to much larger dimensions than designs that use rigid blades attached to the hub as beams. Only two components of the entire design can be in compression: the Rim and the R-clamps, and such compression is moderate. During rotation, increased velocity creates increased centripetal acceleration which builds tensions throughout the Rim. Such tension relieves much of the compression on the R-Clamps and as a result, buckling can be prevented. The Hub of the Tension Windmill supports a wider variety of forces, but its central location and relatively small size ensure that such forces are not problematic for functionality or efficiency.

The superiority of this design is perhaps most readily understood by comparing the fabric Blades to the sails of a sailboat. Like sails, the fabric Blades of the Tension Windmill are thin and present a large area to the wind, thus maintaining a very high effective surface area to weight ratio and allowing for easy scalability. The effect of having a greater sail area of the Blades is especially pronounced in light wind conditions, during which current wind turbine designs are particularly inefficient. The Blades can be constructed of many possible materials, two of which are sailcloth and woven fiberglass tubes. In contrast to other windmill designs which replace rigid blades with sail-like members, the fabric of the Tension Windmill's twisted Blades remain constantly supported on all sides.

The present invention is designed to be used with such controllers that allow movement non-synchronous to the AC line, and that regulate the torque delivered to the mechanism. The motion of each Tension Windmill should be controlled based on present wind conditions, as a function of wind speed, in order to consistently maximize efficiency. The tension-loaded design of the Windmill allows the mechanism to withstand a very wide range of wind conditions without threat of structural damage. Because the Blades are supported by tension, there are no bending forces when the Windmill is rotating at speed, and so increased wind speeds do not increase the gravitational loads borne by the Blades. During extremely heavy winds, when the output power would otherwise be greater than the machine's rated power, the controlled windmill can be unloaded in torque, allowing the Blades to free-wheel and avoid unnecessary stress to the Hub or electro-mechanical components.

### BRIEF DESCRIPTION OF THE SEVERAL VIEWS OF THE DRAWINGS

For a more complete understanding of the present invention, and the advantages thereof, reference is now made to the following descriptions taken in conjunction with the accompanying drawings in which:

FIG. 1 is an axial view of the Tension Windmill mechanism, illustrating the relationship of Hub, Blades, Spokes and Rim;

FIG. 2 is a radial view of the Tension Windmill, with the Rim broken away to show a cross-section of the Rim as well as the orientation of the Blade at the Hub and at the Rim; and

FIG. 3 shows a preferred embodiment for the hub-mounted length adjustment mechanism for the Spokes. One of fourteen is shown in cross-section.

### DETAILED DESCRIPTION OF THE INVENTION

This design for a Tension Windmill can be effectively used in a wide range of dimensions and number of Blades. We intend to first reduce the invention to practice in farm or residential-sized machines rated in the range of one to six kilowatts, sizing the individual components based on readily available commercial stock. We expect a preference for designs with a prime number Blade count, in order to minimize sub-harmonic resonance during rotation. The initial embodiment is designed with the intention that the Rim will be controlled to move at two times the wind speed and all parts and dimensions have been chosen accordingly. In the following description, specific details are set forth to provide a thorough understanding of the present invention, and specifically the preferred embodiment thus far envisioned.

Refer now to the drawings wherein like or similar elements are designated by the same reference numeral by the several views.

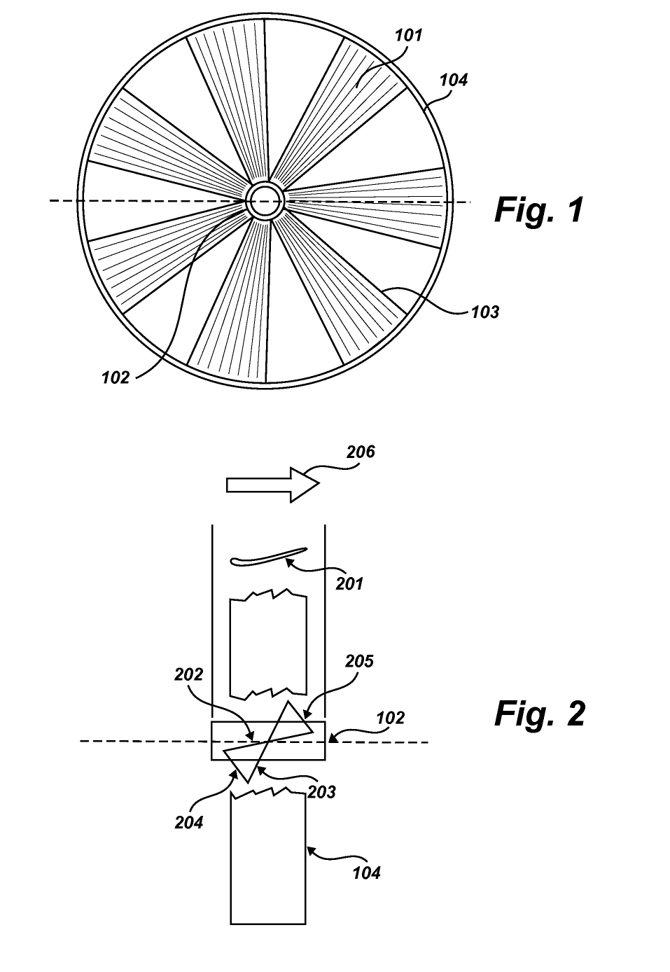

FIG. 1 is a view along the rotational axis of the Tension Windmill. The initial mechanism will have seven Blades 101 supported by a total of fourteen Spokes 103, a central Hub 102 and a Rim 104. The diameter of the Rim is 1.219 m (48″). After optimization and testing for Blade number, size ratios, and materials, the design will be scaled up to larger dimensions. The Blades 101 are attached at the Rim 104 such that the circumferential space in between adjacent Blades 101 is equal to the circumferential width of the Blade 101 at the Rim 104. The fabric of each twisted Blades 101 has equal width at the Hub and at Rim 104.

The seven Blades 101 will be formed from sailcloth, woven fiberglass or a similarly strong fabric that can tolerate compound bends. Each Blade 101 is clamped at its inner and outer edge, and is attached to one Spoke 103 along its leading edge and another Spoke 103 along its trailing edge. The identical fourteen Spokes 103 will be initially constructed of piano wire with a diameter of 0.00305 m (0.12″) and cut to a length of 0.584 m (23″). Each end of a Spoke 103 will have a hot forged head of diameter 0.00457 m (0.18″) re-hardened by water quench. If the Blades 101 were constructed of sailcloth, this manifestation of the Tension Windmill with a diameter of 1.219 m (48″) would require each Spoke 103 to support a weight of less than 2.2 kg (1 lb).

FIG. 2 is a radial view of the Tension Windmill with the Rim 204 broken away, showing the orientation 202 of the Blade at the Hub and the orientation 203 of the Blade at the Rim. The Blade is mounted between two identical Spokes, differentiated as the Leading Spoke 204 and Trailing Spoke 205 with respect to the wind direction 206. While there are multiple potential designs for the shape and substance of the Rim 104, certain of these will have much better strength to weight ratios than others. We envision the Rim 104 to be made of a light metal, such as spun aluminum alloy for smaller models (such as the initial preferred embodiment) and carbon composite for larger-scaled designs. Under loading, the Rim shape proper has tension only, and the R-clamps support some compression. The cross section 201 of an effective Rim should be wing-shaped, with the convex side positioned towards the windmill's Hub. This shape is known to support laminar instead of turbulent airflow, which causes both inefficiency and increased noise. Furthermore, by having the angle of attack of the Rim 104 facing radially inward, the windmill can be efficiently used in higher wind speeds than would otherwise be possible. Wind speed itself generates lift that supports the centripetal acceleration of the Blades 101, which lessens the tension on the Leading and Trailing Spokes 204 and 205, as well as on the bending at the Spokes' connection points with the Rim 104. Also, using a complex curvature to form the Rim 104 (such as a saddle shape) will make the design capable of scaling to the largest dimensions, because this provides the greatest possible strength per unit mass of the Rim's material.

The first manifestation of the Rim 104 will be a spun aluminum alloy part with a wing-shaped cross-section 201. It will have an average diameter of 1.219 m (48″), with a 0.254 m (10″) width in the axial direction and an average thickness of 0.00157 m (0.062″). The Rim 104 will include milled or formed elliptical holes that bear against the Spars and R-Clamps. A total of seven Spars are used at the Rim 104, each of which separates one Blade's leading edge 204 from the trailing edge 205 of the adjacent Blade. Every Spar will be made from aluminum tubing, with outer diameter of 0.0127 m (0.5″) and wall of 0.000711 m (0.028″), and have brass plugs at each end. Each R-Clamp will be formed from identical halves, and each of the fourteen R-Clamp Halves will be sawed from one length of structural aluminum tube with an outer diameter of 0.0159 m (0.625″) and wall of 0.00124 m (0.049″). Every Blade 101 will be clamped by ten brass eyelets that go through the R-Clamp Halves and the Blade 101. One end of each R-Clamp Half is a whole tube with a brass plug, providing strength to the joint with a Spar and Spoke 103. When assembling, the Spoke head passes through the Sleeve, and placement of the Keeper prevents the Spoke head from passing back through the Sleeve. Both the Rim-end and Hub-end of the mechanism require said Sleeves, and they are designated R-Sleeves and H-sleeves respectively. Fourteen R-Sleeves are inserted at assembly to lock the R-Clamp Halves to the Spars. Each will be made from a length of annealed stainless steel tubing and flared to 16° at the female end to mate with the male end of the Keeper. The through inner diameter clears the Spoke end, but not the Keepers.

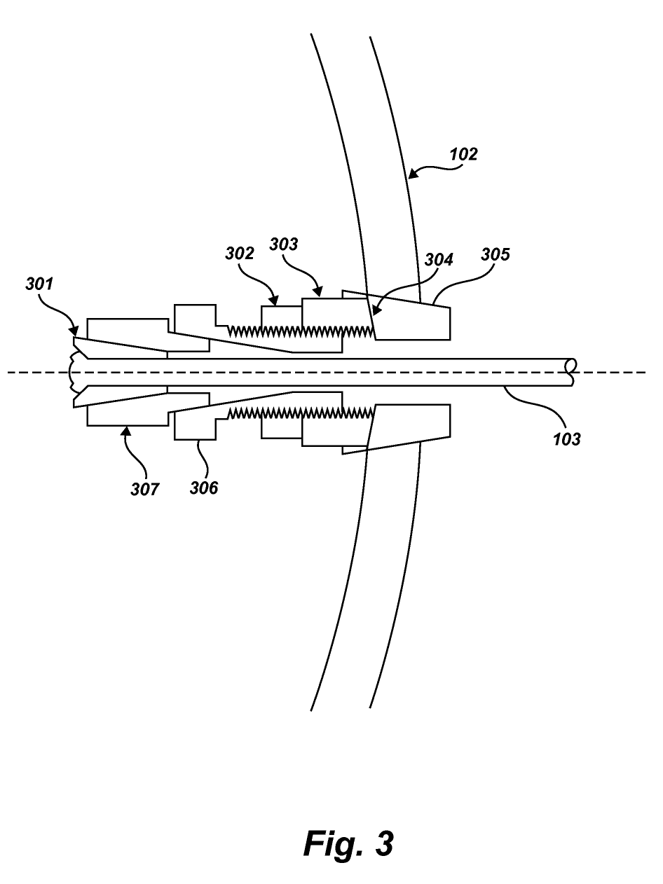

FIG. 3 shows a cross-section of the preferred embodiment for the hub-mounted length adjustment mechanism for the Spokes. The Hub 102 will be machined from aluminum alloy tube stock, with an outer diameter of 0.127 m (5″) and an inner diameter of 0.114 m (4.5″). It will include tapered slots to support fourteen H-Clamps, angled to the axis by arctan ( 1/4.8), approximately 11.77°. The H-Clamps are formed by attaching duplicate half parts 305 machined from aluminum alloy square bar. Two sets of H-Clamp Halves 305 clamp each fabric blade and thereby support the tension of the Blade 101 and Spokes 103 by bearing against the Hub 102. The H-Clamp Halves 305 are bolted to each other and further clamp the Blade 101 by the action of the tapered contact with the Hub 102. One end of each H-Clamp Half 305 has a spherical surface to support a Jack Base 303. These mating spherical surfaces 304 accommodate minor angle deviations of the Spoke 103 from a perfectly radial alignment.

One pair of Keepers 301 will be used at either end of every Spoke 103, making fifty-six Keepers in total. Each Keeper 301 mates with the forged head of the Spoke 103 at one end and with the Sleeve Taper at the other. The Spoke head passes through the H-Sleeve 307, and placement of the Keeper 301 prevents the Spoke head from passing back through the H-Sleeve 307. The fourteen H-Sleeves 307 will be initially machined from hexagonal stainless steel stock, in order to prevent rotation with a common end wrench while the Spoke 103 is tightened into place. The H-sleeve 307 has one female and one male Taper, each of which is an American Standard Taper with an included angle of about 16.6°, or 29.17 cm per meter (3.5″ per foot). The female Taper is in contact with the two Keepers 301 and the male Taper is in contact with a Jack 306.

Each of the fourteen Jacks 306, whose purpose is to tighten the Spoke 103 after assembly, will be a hex head brass bolt machined with a through hole that clears the Spoke head on assembly. The female Taper is at the head, and mates with the male Taper of the H-sleeve 307. Male threads of the Jack 306 mate with the female threads of the Jack Base 303. They provide length adjustment when the H-Sleeve 302 and Jack Base 303 are prevented from turning by two wrenches while the Jack 306 is turned by a third wrench. After adjustment the Jam Nut 302 is tightened against the Jack Base 303 and prevents any further motion between threaded parts. The outer end of the Jack Base 303 is male spherical, and mates with one H-Clamp Half 305.

Although the present invention and its advantages have been described in detail, it should be understood that various changes, substitutions and alterations can be made herein without departing from the spirit and scope of the invention as defined by the appended claims.

What is claimed is:

1. The portion of an axial windmill that is in direct contact with the wind comprising a plurality of Blades, wherein said Blades
are made from material, such as sailcloth, that can tolerate compound bends and will only support tension;
have straight line edges; and
are twisted into a shape that maintains a smoothly varying angle of attack between the Blade and the wind direction at any radial distance along the Blade.

2. The invention in accordance with claim 1 wherein the twisted shape is such that the free wheeling angular velocity of each Blade is approximately the same for any radial element of that Blade.

3. The invention in accordance with claim 2 wherein the Blades are mounted to a Hub by means of Spokes and a Rim, and wherein the Spokes are very narrow so that the only substantial force that the Spokes will support is tension.

4. The invention in accordance with claim 3 wherein the width of each Blade at the Hub is equal to the width of that Blade at the Rim, and said Blade has a near-constant width for any radial element of that Blade. Said near-constant width and twisted shape of each Blade are created by the placement of the ends of two supporting narrow Spokes at said Rim and said Hub.

5. The invention in accordance with claim 4 additionally comprising Spoke length adjustment mounted at the Hub.

6. The invention in accordance with claim 5 wherein the cross-section of the Rim is wing-shaped for smoothing the flow of air over the Rim.

7. The invention in accordance with claim 6 in which said cross-section of the Rim has an angle of attack radially inward for adding lift to the Spoke tension in order to provide the force necessary for the centripetal acceleration of each circumferential element of the Rim.
